(19) United States
(12) Patent Application Publication
(10) Pub. No.: US 2026/0121762 A1
(43) Pub. Date: Apr. 30, 2026

(54) Redundant Multiple Light Emitting Diode Pulse Amplitude Modulation System

(71) Applicant: Cspeed Inc., Palo Alto, CA (US)

(72) Inventors: Sanjai Kohli, Los Altos Hills, CA (US); Paul Chun-Hsiung Wei, San Jose, CA (US)

(73) Assignee: Cspeed Inc., Palo Alto, CA (US)

(21) Appl. No.: 18/930,088

(22) Filed: Oct. 29, 2024

(51) Int. Cl. H04B 10/54; H04B 10/11

(52) U.S. Cl. CPC H04B 10/541; H04B 10/11

(57) ABSTRACT

Apparatuses, methods, and systems for Pulse Amplitude Modulation (PAM) N light emitting diodes are disclosed. A system includes greater than (N−1) LEDs, each LED configured to generate light for propagation through a medium when the LED is activated, and a controller configured to control activation of each of the greater than (N−1) LEDs depending on which of the N levels of a PAM signal is to be transmitted through the medium.

### FIELD OF THE DESCRIBED EMBODIMENTS

The described embodiments relate generally to optical communications. More particularly, the described embodiments relate to systems, methods, and apparatuses for a redundant multiple LED (light emitting diode) PAM (pulse amplitude system).

### BACKGROUND

A carrier signal of light of an LED can be modulated to carry information over an optical cable. Increasing the signal power of the light can improve the SNR (signal to noise ratio) of the information being transmitted over the optical cable. LEDs, however, may fail after a lifetime of operation.

It is desirable to have methods, apparatuses, and systems for a redundant multiple LED (light emitting diode) PAM (pulse amplitude system).

### SUMMARY

An embodiment includes a Pulse Amplitude Modulation (PAM) N light emitting diode (LED) system. The system includes greater than (N−1) LEDs, each LED configured to generate light for propagation through a medium when the LED is activated, and a controller configured to control activation of each of the greater than (N−1) LEDs depending on which of N levels of a PAM signal is to be transmitted through the medium.

Another embodiment includes a method of operating a Pulse Amplitude Modulation (PAM) N light emitting diode (LED) system. The method includes generating, by greater than (N−1) LEDs, light for propagation through a medium, wherein each LED generates light when the LED is activated, and controlling, by a controller, activation of each of the greater than (N−1) LEDs depending on which of N levels of a PAM signal is to be transmitted through the medium.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an LED that is modulated by a PAM signal, according to an embodiment.

FIG. 2 shows greater than (N−1) LEDs that are selectable to generate a PAM N optical signal, according to an embodiment.

FIG. 3 shows greater than (N−1) groups of LEDs that are selectable to generate a PAM N optical signal, according to an embodiment.

FIG. 4 shows a selectable bank of LEDs wherein each LED is selected by a controller to generate a PAM N optical signal, according to another embodiment.

FIG. 5 shows a substrate that includes greater than (N−1) LEDs that are selectable to PAM N optical signal for transmission over an optical fiber, according to an embodiment.

FIG. 6 shows a flow chart that includes steps of a method of operating a Pulse Amplitude Modulation (PAM) N light emitting diode (LED) system, according to an embodiment.

### DETAILED DESCRIPTION

The embodiments described include methods, apparatuses, and systems for a redundant multiple LED (light emitting diode) PAM (pulse amplitude system). The described embodiments include greater than (N−1) LEDs for generating an optical PAM (pulse amplitude modulation) signal having N modulation levels. As compared to a single LED PAM system, the described systems and methods provide increased signal power which improves the SNR of a generated modulated optical carrier signal. Further, the described embodiments provide for a simple optical modulator that does not require directly modulating an LED. Further, the described embodiments provide for redundancy of LEDs which improves the reliability and lifetime of the PAM system. Upon detecting failure of one or more of the greater than (N−1) LEDs, the failed one or more LEDs can be avoided in future generation of the PAM signals.

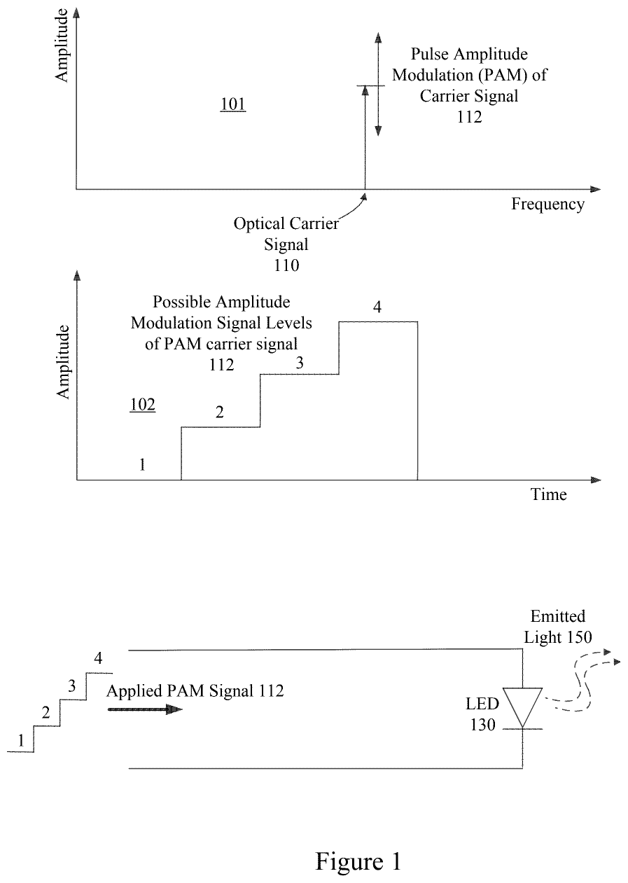

FIG. 1 shows an LED 130 that is modulated by a PAM signal 112, according to an embodiment. Plot 101 shows an optical carrier signal 110 that is modulated by the PAM signal 112. Plot 102 shows possible amplitude levels of a PAM 4 version of the PAM signal 112. As shown, the PAM signal 112 is applied to the LED 130 to generate the PAM N (4) modulated carrier signal in the form of emitted light 150. For an embodiment, the emitted light 150 is configured to propagate across an optical fiber for providing optical communications across the optical fiber.

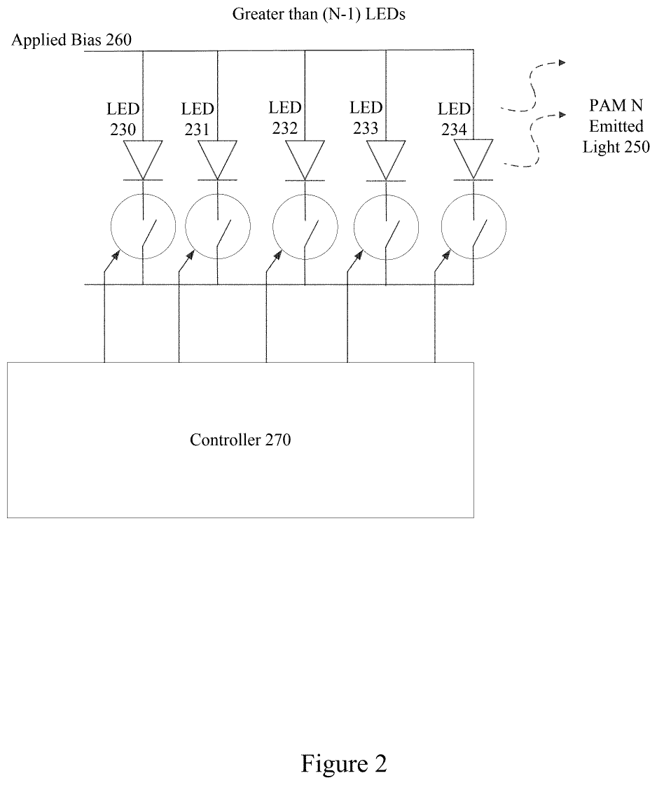

FIG. 2 shows greater than (N−1) LEDs 230, 231, 232, 233, 234 that are selectable to generate a PAM N optical signal, according to an embodiment. The selected ones of the LEDs generate an optical carrier signal (emitted light 250) having a PAM level as determined by the selected one of the LEDs. For an embodiment, a controller 270 selects which of the LEDs are active by applying a bias voltage V_0 to the selected LED(s). That is, the selected LED(s) are turned to an on state or active state by applying the voltage to V_0 (V_on) across the selected LED(s).

As an example, a PAM 4 system which includes 4 different levels of PAM, requires at least 3 LEDs. For example, a state mapping of selected LED may be provided by the following table which includes a mapping of selected LEDs for each of the 4 (N) levels of the PAM, and includes redundancy to extend the life of the system.

| | |
|---|---|
| Strict mapping | Preferred |

| Bits | Led0 | Led1 | Led2 | Mapping |
|---|---|---|---|---|
| 0 0 | Off | Off | Off | All LEDs off |
| 0 1 | On | Off | Off | Any 1 LED on |
| 1 0 | On | On | Off | Any 2 LEDs on |
| 1 1 | On | On | On | All LEDs on |

However, additional (greater than N−1) LEDs may be included in the modulation system to provide redundancy of LEDs. For example, the LEDs 230, 231, 232, 233, 234 of FIG. 2 support a PAM 4 system having 4 different levels of modulation, and further provide 2 extra LEDs for redundancy. Therefore, if up to 2 of the LEDs 230, 231, 232, 233, 234 fails, the system is still operable with the remaining 3 LEDs.

The number of redundant LEDs of the PAM system can be selected based on testing of the LEDs for, for example, a 5-year burn-in. That is, a 5-year burn in suggests that a certain percentage of LEDs will fail. Based on this percentage, the number of LEDs to be utilized for a PAM N system can be selected to ensure that the PAM system is operational for greater than 5 or some other selected number of years.

It is to be observed that the system of FIG. 2 that includes the greater than (N−1) selectable LEDs provides greater signal power than the single LED system of FIG. 1. Several variables of the system can be defined by the following table.

| Name | Description |
|---|---|
| N | Pam N system |
| Pmin | Minimum LED output level |
| Pmax | Maximum LED output level |
| Power_led_avg | Average LED output power |
| Power_sys_avg | Average system output power |
| RIN | Relative Intensity noise of LED |
| Plevel | PAM level separation |

For a system using M LEDs, the power is improved by M times over the single LED system. That is the Power_led_avg=(Pmax+Pmin)/2 and Power_sys_avg=M Power_led_avg.

The N LED system of FIG. 2 provides a simple design in which system power output is (N−1) times larger than single LED system. Further, each LED can be driven without linearity issues as needed in PAM N systems whether using direct or external modulation with a single LED. Further, the higher output power (as compared to a single LED system) enhances the link margin for the system which can be used to compensate, for example, for. As an additional losses resulting from a longer cable used as the transmission channel.

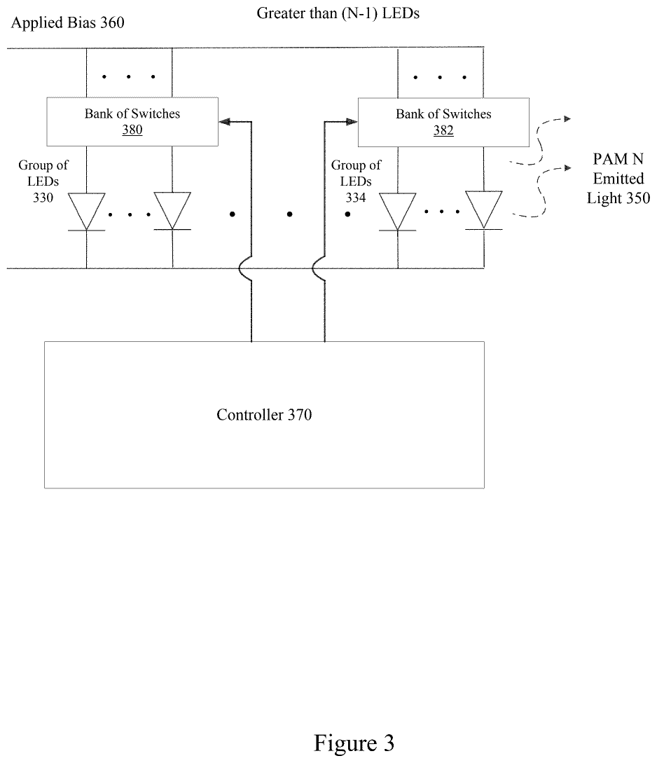

FIG. 3 shows greater than (N−1) groups of LEDs that are selectable to generate a PAM N optical signal, according to an embodiment. As shown, for this embodiment, each of the LEDs of FIG. 2 have been replaced by multiple LEDs or groups of LEDs 330, 334. The addition of the selectable groups 330, 334 of LEDs increases the signal level of the optical carrier signal (PAM N emitted light 350) for each selection. Further, the additional LEDs provide even more redundancy which improves reliability of the PAM system. For an embodiment, a controller 370 selects which of the LEDs groups 330, 334 are active, and thereby generating an optical signal at the carrier frequency. Applied bias 360 provides for activation of the selected LEDs. Banks of switches 380, 382 are used to select which of the LEDs from each of the groups 330, 334 of LEDs are active.

For an embodiment, if space permits, each LED may be replaced with M LEDs to obtain additional power. Therefore, the PAM N system would include (N−1)*M LEDS and the power increase in the generated optical carrier signal would increase by (N−1)*M over a single LED system.

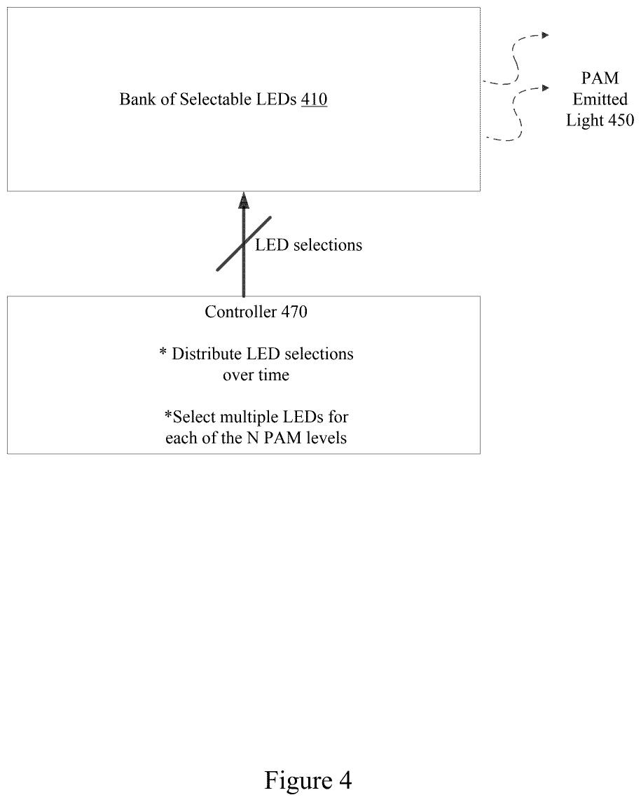

FIG. 4 shows a selectable bank of LEDs 410 wherein each LED is selected by a controller 470 to generate a PAM N optical signal, according to another embodiment. The selectable bank of LEDs 410 includes the greater than (N−1) LEDs of the PAM N system. Similar to the systems of FIG. 2 and FIG. 3, LEDs are selected for each of the N levels of the PAM signal. However, many more than (N−1) LEDs can be selected from within the selectable bank of LEDs 410. The number of LEDS included within the selectable bank of LEDs 410 can be selected based on the desired power level of the generated optical carrier signal at each signal level (PAM emitted light 450) and the desired level of redundancy.

For at least some embodiments, the controller 450 distributes the LED selections for each of the N levels of the PAM N signal over time. This can greatly improve the reliability of the PAM system because the selection time for each individual LED is reduced. That is, the operational life of each of the LEDs is improved because over any period that each LED is selected and operates to generate light over time is less than if fewer LEDs were used. For example, referencing the previously described table of LED selections for a PAM4 signal, the selected LED(s) for each level can be changed each time a level is selected. For example, the mapping for each level can be distributed over time by incrementing the starting LED position after each PAM transmission. For example, the PAM level 1 may be generated by a single LED being activated, and each time the PAM level 1 is generated, a different one of the LEDs may be successively selected. Same with, for example, the PAM level 2 in which two LEDs may be selected, but each successive PAM level 2 generation uses a different two of the LEDs. There are many possible ways to distribute, but the primary premise is to vary the LEDs selected for each PAM level over time as to distribute the use of each of the LEDs which prolongs the lifetime of each of the LEDs. The less an LED is selected, the longer the life of the LED.

For an embodiment, a selected subset of the LEDs may be avoided during the selection so that the avoided selected subset are available if one or more of the selected LEDs begin to fail. For an embodiment, an amount of current conducted by each LED when selected can be used to determine that the LED is nearing failure. That is, when closer to failure, some LEDs will begin to conduct more current. Accordingly, LEDs that are sensed to be conducting more current (that is, more than the other LEDs or more than a threshold level of current) can be avoided in the selection of LEDs for generating each of the levels of the PAM signal.

Further, for an embodiment, the number of LEDs selected for each of the N PAM levels is determined by the controller 470. Further, the number of LEDs selected for each of the N PAM levels can change over time. For example, if over time the power level of the emitted light for each LED decreases over time due to aging, the number of LEDs selected can change to mitigate the reduced emitted power level of each LED over time to ensure a desire power level of the generated carrier signal of the PAM signal.

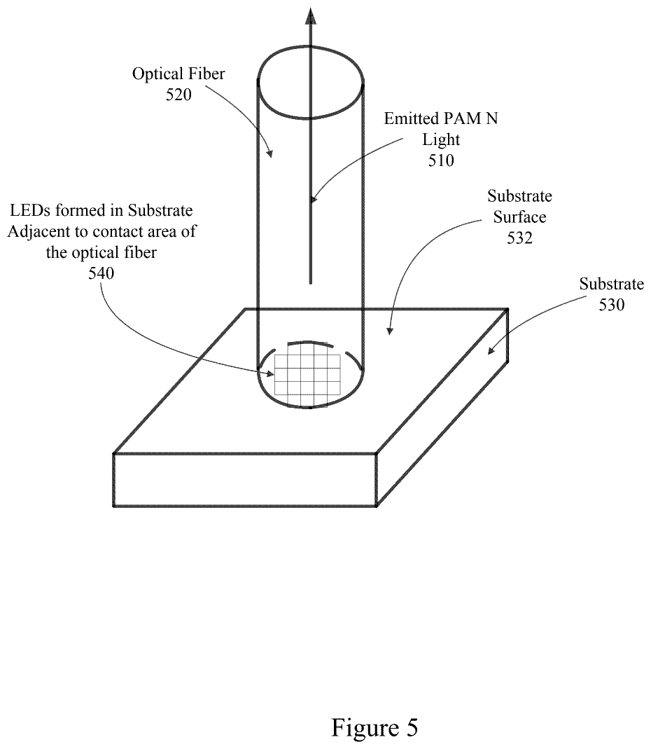

FIG. 5 shows a substrate that includes greater than (N−1) LEDs 540 that are selectable to PAM N optical signal for transmission over an optical fiber 520, according to an embodiment. As shown, the greater than (N−1) LEDs 540 of a PAM N system are formed in a substrate 530. Further, the optical fiber 520 is attached to the substrate adjacent or covering the greater than (N−1) LEDs 540. That is, the optical fiber 520 is attached to a surface 532 of the substrate 530 over that greater than (N−1) LEDs 540. The selected ones of the greater than (N−1) LEDs 540 generate light of an optical carrier signal (emitted PAM N light 510) that propagates through the optical fiber 520.

For an embodiment, the number of greater than (N−1) LEDs is additionally selected based on an area of a cross section of the optical fiber 520 and on a size of each of the LEDs of the greater than (N−1) LEDs 540. For an embodiment, the optical fiber 520 is attached to the surface 532 of the substrate 530 that includes the greater than (N−1) LEDs 540, wherein the greater than (N−1) LEDs 540 are located on the substrate 530 where the optical fiber 520 is attached.

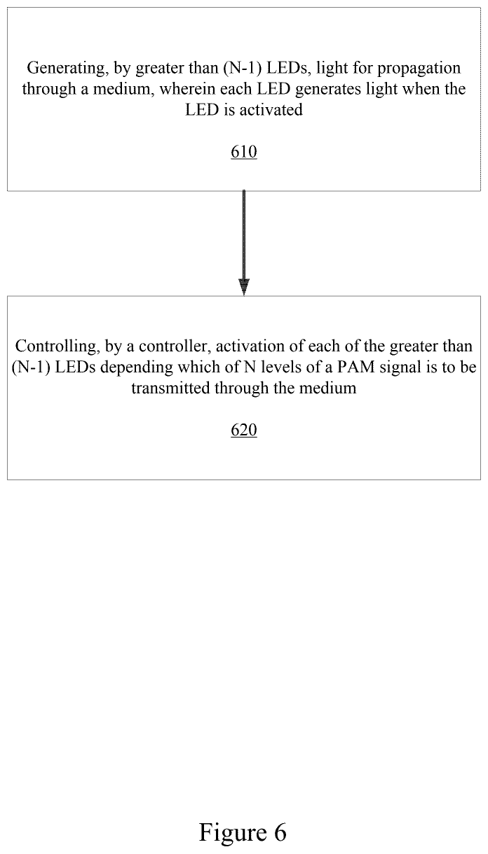

FIG. 6 shows a flow chart that includes steps of a method of operating a Pulse Amplitude Modulation (PAM) N light emitting diode (LED) system, according to an embodiment. A first step 610 includes generating, by greater than (N−1) LEDs, light for propagation through a medium, wherein each LED generates light when the LED is activated. A second step 620 includes controlling, by a controller, activation of each of the greater than (N−1) LEDs depending on which of N levels of a PAM signal is to be transmitted through the medium.

For an embodiment, the number of greater than (N−1) LEDs is selected based on the redundancy, LED usage leveling, and a life expectancy of each of the LEDs. The redundancy indicates how many extra LES are being used. That is, how many more LEDs there are than the number of PAM levels being generated. For an embodiment, LED usage leveling indicates how the selections of the LEDs are distributed over time for each of the PAM level selections. The LED usage level provides a indication of how often each LED is selected over time in the generation of the levels of the PAM signal. The life expectancy provides an indication of how long each LED is expected to last, and can be used in the determination of the redundancy.

For an embodiment, the medium includes an optical fiber, and the number of greater than (N−1) LEDs is additionally selected based on an area of a cross section of the optical fiber and on a size of each of the LEDs. For an embodiment, the optical fiber at attached to a surface of a substrate that includes the greater than (N−1) LEDs, wherein the greater than (N−1) LEDs are located on the substrate where the optical fiber is attached.

For an embodiment, each of the greater than (N−1) LEDs comprises a plurality of sub-LEDs, thereby providing greater signal power for each of the N levels than provided by a single LED at each of the levels. For an embodiment, one or more of the greater than (N−1) LEDs are selected for each of the levels of the PAM signal, and wherein each of the greater than (N−1) LEDs comprises M sub-LEDs, thereby providing greater signal power for each of the N levels than provided by a single LED at each of the levels.

For an embodiment, the greater than (N−1) LEDs are included within a selectable bank of LEDs wherein the controller is configured to select which of the bank of LEDs are active at any point in time. For an embodiment, which LEDs are selected for each of the N levels of the PAM signal changes over time as determined by the controller. At least some embodiments further include selecting LEDs of the bank of LEDs for each of the N levels of the PAM signal, wherein the selection of LEDs for each of the N levels over time changes to control how often any single one of the LEDs is activated. At least some embodiments further include selecting redundant LEDs for each of the N levels of the PAM signal to enhance signal power of the generated light.

Although specific embodiments have been described and illustrated, the embodiments are not to be limited to the specific forms or arrangements of parts so described and illustrated. The described embodiments are to only be limited by the claims.

What is claimed:

1. A Pulse Amplitude Modulation (PAM) N light emitting diode (LED) system, comprising:
greater than (N−1) LEDs, each LED configured to generate light for propagation through a medium when the LED is activated;
a controller, the controller configured to control activation of each of the greater than (N−1) LEDs depending on which of N levels of a PAM signal is to be transmitted through the medium.

2. The system of claim 1, wherein a number of greater than (N−1) LEDs is selected based on redundancy, LED usage leveling, and a life expectancy of each of the LEDs.

3. The system of claim 2, wherein the medium includes an optical fiber, and the number of greater than (N−1) LEDs is additionally selected based on an area of a cross section of the optical fiber and on a size of each of the LEDs.

4. The system of claim 3, wherein the optical fiber is attached to a surface of a substrate that includes the greater than (N−1) LEDs, wherein the greater than (N−1) LEDs are located on the substrate where the optical fiber is attached.

5. The system of claim 1, wherein each of the greater than (N−1) LEDs comprises a plurality of sub-LEDs, thereby providing greater signal power for each of the N levels than provided by a single LED at each of the levels.

6. The system of claim 1, wherein one or more of the greater than (N−1) LEDs are selected for each of the levels of the PAM signal, and wherein each of the greater than (N−1) LEDs comprises M sub-LEDs, thereby providing greater signal power for each of the N levels than provided by a single LED at each of the levels.

7. The system of claim 1, the greater than (N−1) LEDs are included within a selectable bank of LEDs wherein the controller is configured to select which of the bank of LEDs are active at any point in time.

8. The system of claim 7, wherein which LEDs are selected for each of the N levels of the PAM signal changes over time as determined by the controller.

9. The system of claim 8, further comprising the controller being configured to:
select LEDs of the bank of LEDs for each of the N levels of the PAM signal, wherein the selection of LEDs for each of the N levels over time changes to control how often any single one of the LEDs is activated.

10. The system of claim 9, wherein the controller is further configured to select redundant LEDs for each of the N levels of the PAM signal to enhance signal power of the generated light.

11. A method of operating a Pulse Amplitude Modulation (PAM) N light emitting diode (LED) system, comprising:
generating, by greater than (N−1) LEDs, light for propagation through a medium, wherein each LED generates light when the LED is activated;
controlling, by a controller, activation of each of the greater than (N−1) LEDs depending on which of N levels of a PAM signal is to be transmitted through the medium.

12. The method of claim 11, wherein a number of greater than (N−1) LEDs is selected based on redundancy and a life expectancy of each of the LEDs.

13. The method of claim 12, wherein the medium includes an optical fiber, and the number of greater than (N−1) LEDs is additionally selected based on an area of a cross section of the optical fiber and on a size of each of the LEDs.

14. The method of claim 13, wherein the optical fiber is attached to a surface of a substrate that includes the greater than (N−1) LEDs, wherein the greater than (N−1) LEDs are located on the substrate where the optical fiber is attached.

15. The method of claim 11, wherein each of the greater than (N−1) LEDs comprises a plurality of sub-LEDs, thereby providing greater signal power for each of the N levels than provided by a single LED at each of the levels.

16. The method of claim 11, wherein one or more of the greater than (N−1) LEDs are selected for each of the levels of the PAM signal, and wherein each of the greater than (N−1) LEDs comprises M sub-LEDs, thereby providing greater signal power for each of the N levels than provided by a single LED at each of the levels.

17. The method of claim 11, the greater than (N−1) LEDs are included within a selectable bank of LEDs wherein the controller is configured to select which of the bank of LEDs are active at any point in time.

18. The method of claim 17, wherein which LEDs are selected for each of the N levels of the PAM signal changes over time as determined by the controller.

19. The method of claim 18, further comprising:
selecting LEDs of the bank of LEDs for each of the N levels of the PAM signal, wherein the selection of LEDs for each of the N levels over time changes to control how often any single one of the LEDs is activated.

20. The method of claim 19, further comprising selecting redundant LEDs for each of the N levels of the PAM signal to enhance signal power of the generated light.
